(19) United States
(12) Patent Application Publication
(10) Pub. No.: US 2011/0071971 A1
(43) Pub. Date: Mar. 24, 2011

(54) MULTI-LEVEL EVENT COMPUTING MODEL

(75) Inventors: Gregory H. Parks, Redmond, WA (US); William H. Mitchell, Medina, WA (US); Robert D. Copeland, Redmond, WA (US)

(73) Assignee: MICROSOFT CORPORATION, Redmond, WA (US)

(21) Appl. No.: 12/564,913

(22) Filed: Sep. 22, 2009

(51) Int. Cl. G06F 17/00; G06N 5/00

(52) U.S. Cl. 706/45; 703/17

(57) ABSTRACT

High-order events may be generated and consumed in a cascading computing model. Low level information, such as changes in physical sensor readings, may be communicated to an application in the form of event messages that are generated by an operating system service. In one example, models that implement high level abstractions may also use events to communicate facts that have been inferred from lower level facts. For example, a program might generate events indicating that a particular type of motion (e.g., walking) has started or stopped, where the program infers the walking motion from sensor data about acceleration and position. Another program could consume those events and other data to draw higher level conclusions, such as “Joe is walking to a meeting”. Thus, events may be used in a cascading model in which events are generated and consumed at increasingly high levels of abstraction.

### BACKGROUND

Machines are often equipped with sensors that provide the machines with information about their external environment. For example, a computer may have external sensors such as accelerometers, thermometers, Global Positioning System (GPS) receivers, or other devices that obtain information about the computer's external environment. In addition to computers themselves, many types of machines (e.g., cars, telephones, kitchen appliances, etc.) have computing capability and may have such sensors.

Typically, the operating system at a computer or other machine provides an interface through which applications may access the raw data generated by the sensors. For example, an operating system may provide an Application Programming Interface (API) that allows an application program, or even another component of the operating system, to read the sensors. The API might allow the device to request a reading of the sensors on demand, or might allow an application to subscribe to event notifications such as changes in a sensor reading. So, if an application wants to know the current latitude and longitude of the device, it could use the API to obtain the current reading from the GPS receiver. Or, if the application wants to know the current acceleration of the device, it could use the API to obtain a reading of the current acceleration vector.

Obtaining sensor readings provides data about the environment. However, this type of low level data often is of no interest to typical users and the applications that they use. A scientist who carries a cell phone equipped with an accelerometer and GPS receiver may find it interesting to see the raw sensor readings. However, typical users (and the applications that they use) do not care so much about raw location data (e.g., “you are at 47.64852 north latitude, 122.13928 west longitude”); rather, they care about higher-level issues and descriptions (e.g., “you are on the Microsoft campus”). Applications typically provide information to users based on complex models use many different kinds of data from many sources, and these applications typically find it convenient to deal with high-level abstractions rather than raw sensor data.

### SUMMARY

A system may support the use events that are generated from high-level reasoning about low-level information. Low-level information (such as changes in the readings of physical sensors) could be provided as input to models that apply high-level abstractions. These models could form conclusions, and the conclusions are higher-order facts about which events may be communicated. These events may be provided as input to other models, which may form their own conclusions, from which events may be generated. Dependencies among the different levels of events may form a cascading structure, in which models that implement increasingly high levels of abstraction depend on events generated at lower levels of abstraction. Events at any level may be consumed by programs, which use the events to make decisions.

For example, sensors such as an accelerometer and a GPS receiver may provide low-level information about the motion and location, respectively, of the device to which the sensors are attached. The interface though which these sensors are accessed may generate an event if either the acceleration vector or position changes. This low-level information may be provided as input to a higher level model, which may use the information to draw inferences about how the device, to which the sensors are attached, is being moved. For example, changes in latitude and longitude (as indicated by the GPS receiver) and changes in the acceleration vector (as indicated by the accelerometer) may suggest that the device is being moved somewhere. Inferring the nature of this motion (e.g., walking, running, driving, etc.) may involve applying complex physical models to the raw sensor data. A program that implements the model may draw a conclusion about the nature of the motion. For example, the program might conclude that the device is being carried by a person who is walking—e.g., based on the rate of change in the latitude and longitude, and based on the pattern of change in the acceleration vector. At that point, “is walking” may be treated as a fact, and the program that inferred the fact may generate events surrounding the fact: e.g., walking has started, walking has stopped, etc. Although there may be no sensor that can directly sense the fact that walking has started or stopped, an appropriate model can infer this fact from low level sensor information, and thus can generate “higher-order” events related to the inferred fact. These higher-order events can be communicated to, and consumed by, other program.

In one example, models that implement increasingly high level abstractions may consume lower-level events in a cascading structure. For example, one program may read the GPS and accelerometer data to determine whether the “is walking” fact applies to the device (or, more precisely, to the person who is carrying the device). Another program may consume “is walking” events, may combine these events with information retrieved from a database that associates devices with their owners, and may use this combined information to conclude that “Joe is walking” (e.g., if the database shows that Joe is the owner of the device). Yet another program may consume the “Joe is walking” events and may combine them with Joe's calendar data to draw conclusions such as “Joe is walking to a meeting with the company president” (if such a meeting appears on Joe's calendar at roughly the time that Joe is walking). Yet another program may consume events such as “Joe is walking to a meeting with the company president” with readings from Joe's heart rate monitor to conclude “Joe is tired.” In this way, models may consume higher-order events and low-level sensor events in a similar manner.

There may be various types of information that surround events. For example, a model may infer a fact with some level of confidence, and events may be generated that indicate the level of confidence and/or changes thereto. For example, after analyzing sensor data a model might find that it is ambiguous whether the person carrying the device is walking, but might find that there is an 80% probability that the sensor data was generated by a walking motion. Thus, the model might generate an event that indicates that walking has commenced, and the event may indicate that there is 80% certainty the event accurately describes what the person is doing. Additionally, the model may form certain conclusions about how relevant the event is to the presumed consumer of the event, or the rate at which the reliability of the information decays, and these conclusions may be communicated as part of the events.

Events from several different sources may be combined. In one example, low-level events are read from a single device, and the use of models to generate higher-order events takes place on the same device. In another example, the various low- and high-level events are generated on various different devices, and are consumed across devices in a distributed arrangement.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example arrangement in which events may be generated and consumed.

FIG. 2 is a block diagram of an example of cascading higher-order events.

FIG. 3 is a block diagram of an example scenario in which events are generated and consumed across a plurality of machines in a distributed environment.

FIG. 4 is a flow diagram of an example process in which events may be generated and/or consumed.

FIG. 5 is a block diagram of example of information that may be communicated with an event.

FIG. 6 is a block diagram of example components that may be used in connection with implementations of the subject matter described herein.

### DETAILED DESCRIPTION

Computers, and other machines that have computing capability, often include physical sensors that provide information about the surrounding environment. For example, a machine might be equipped with a light sensor, thermometer, accelerometer, Global Positioning System (GPS) sensor, or other kinds of sensor devices. Software running on the machine can access these sensor readings. In one example, the operating system on the machine provides an Application Programming Interface (API) through which software can obtain the sensor readings. The API might provide functions that allow software to request readings on demand, or might provide a mechanism that allows software to subscribe to sensor events and that pushes the events to the software in the form of messages.

One issue that arises is that users are rarely interested in raw sensor data. Users (and, by extension, the software that they use) are typically interested in high level concepts, such as “where is a person traveling to.” Raw low-level sensor data such as acceleration vectors and GPS readings can be used to infer high-level facts, but the high-level facts themselves are not sensed directly; instead, they are normally based on abstract models of how to interpret the raw sensor data. Software generally deals with the world at some level of abstraction that is convenient for the software's goal, but low-level sensor data deals with the world only at the basic physical level. If a user is carrying a device such as a handheld computer, it might be convenient for an application on that computer simply to have the operating system notify the application of high level facts. For example, an application might be designed to notify the user of the onset of fatigue, so it would be convenient if the application could simply ask the operating system to notify the application that the person carrying the device is tired. Tiredness can be modeled from various facts—e.g., the amount of walking a person has done, the outdoor temperature, the person's age, the person's heart rate, etc. However, there is no sensor that directly senses tiredness. If an application is interested in basic physical facts such as the temperature, then it is possible to access those facts through the operating system's mechanisms for reading sensor values. However, the mechanisms that the operating system provides for accessing sensor data typically do not handle data from components other than the sensors. That is, a mechanism that allows an application to subscribe to sensor events does not necessarily allow an application to subscribe to events that are generated through some higher-level model.

The subject matter described herein provides a system in which high level abstractions and low level event data may be deal with in a unified and comprehensive way. As noted above, an application may subscribe to sensor events, and may receive sensor events from a mechanism provided by the operating system. The subject matter herein allows programs that implement higher-level abstractions to generate events, and these events may be used in a manner that is similar to how sensor events are used. Models may use the events as input and may also generate their own events to be used by other models. Thus, high level abstractions may be built in a cascading structure, in which one model consumes lower-level events, and generate events to be consumed by other models at increasingly high-levels of abstractions. For example, a first model might determine whether the person carrying a particular device is walking, based on events that describe changes in acceleration, latitude, and longitude. Once the model determines whether the person is walking, then “is walking” becomes a fact, and an application can subscribe to event notifications of that fact. A second model might try to determine were the person is walking based on (a) the first model's determination of whether the person is walking, and (b) what events are on the person's calendar. Once the second model determines where the person is walking, it can issue events like “Joe has started walking to a meeting with the company president.” Those events could be subscribed to by applications. A third model might attempt to determine whether a person is tired, and might do so based on (a) how much walking the person has done (as determined from the “is walking” events), and (b) the person's heart rate (which might be determined by subscribing to events from a heart rate monitor). Once the third model makes a determination of whether the person is tired, it may generate events which can be subscribed to by other applications. In other words, increasingly high-level concepts can be used to generate events, which can then be consumed by programs that want to deal with facts at high levels of abstractions.

The subject matter herein may be used to manage high-level events on a single machine. However, events may also be used across machines in a distributed environment. For example, a program on one machine could subscribe to sensor readings taken on other machines, or could subscribe to higher-level events that are calculated on other machines.

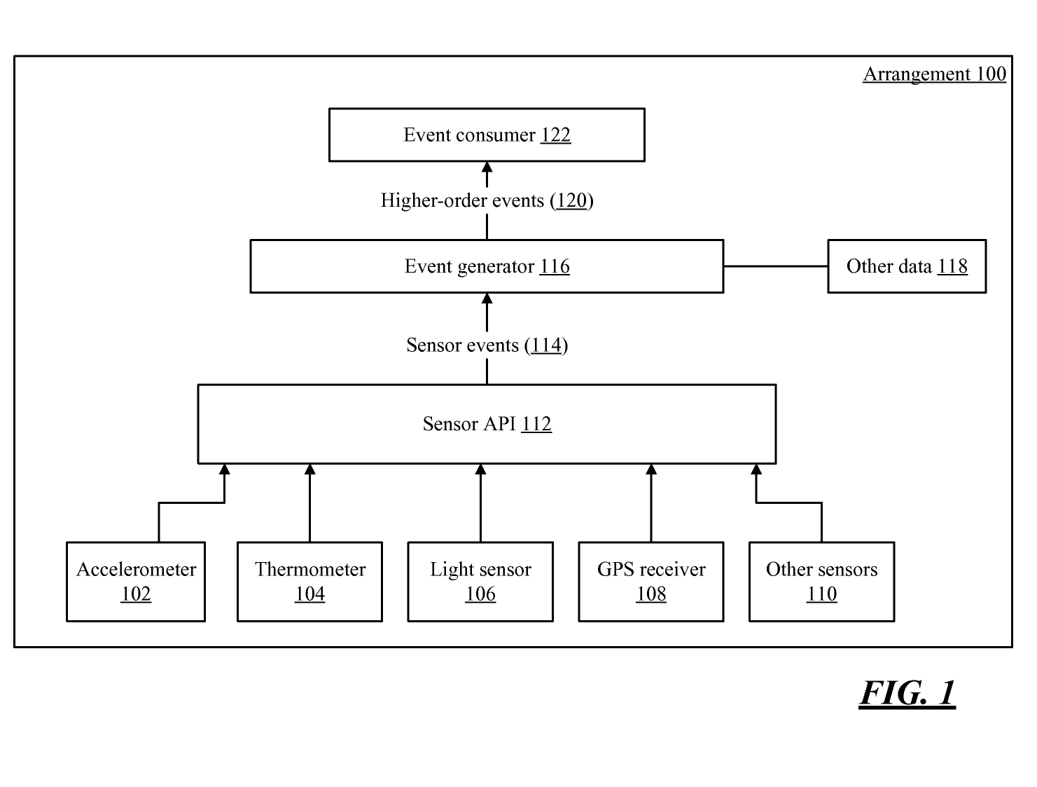

Turning now to the drawings, FIG. 1 shows an example arrangement 100 in which events may be generated and consumed. Arrangement 100 may be a computer, another type of machine (e.g., cell phone, automobile, audio/video component, etc.), or a collection of computer(s) and/or other machine(s). It is noted that the techniques described herein may be implemented on a single machine, or may be distributed across an arbitrary number of machines.

In the example of FIG. 1, arrangement 100 may comprise sensors such as accelerometer 102, thermometer 104, light sensor 106, Global Positioning System (GPS) receiver 108, or other sensors 110. These sensors may provide information about physical conditions that are present in the environment of the device to which the sensors are attached. Accelerometer 102 is a device that is attached in some manner to arrangement 100. (In the example where arrangement 100 comprises plural machines, accelerometer 102 may be attached to one of the machines that is part of arrangement 100.) Accelerometer 102 senses acceleration on arrangement 100 to which it is attached (or the machine to which it is attached within arrangement 100). Accelerometer may generate data, such as a vector that describes the magnitude and direction of acceleration at some point in time. This data may be used by software using techniques that are described below.

Thermometer 104 senses the temperature present at arrangement 100 (or at a machine within arrangement 100). Light sensor 106 senses the presence of light at arrangement 100 (or at a machine within arrangement 100). GPS receiver 108 communicates with satellites to triangulate the location of arrangement 100 (or of a machine within arrangement 100). Thermometer 104, light sensor 106, and GPS receiver 108 may generate data based on the information that they sense. For example, thermometer 104 may generate a temperature in degrees Celsius. Light sensor 106 may generate data that describes the light that has been detected (where the data, for example, may represent the light as a vector in some color space such, as the hue-saturation-lightness space or the red-green-blue space). GPS receiver 108 may represent a machine's position in some coordinate system, such as latitude and longitude. Accelerometer 102, thermometer 104, light sensor 106, and GPS receiver 108 are examples of sensors that may be present at arrangement 100, although other sensors 110 may be present, and other sensors 110 may be any type of sensor(s).

Sensor Application Programming Interface (API) 112 provides an interface through which programs that run on arrangement 100 may obtain information from sensors. For example, sensor API 112 may provide functions that programs can invoke in order to read the sensors. Or, sensor API 112 may provide a mechanism by which programs can register for event notifications, whereby programs can receive message when events with respect to the sensors occur. An example of an event that may occur with respect to a sensor is a change in a sensor's value—e.g., if the temperature changes, then thermometer 104 may experience a change in value that may be communicated by a message. Another example of an event is the expiration of a timer that causes a sensor's current value to be communicated. For example, sensor API 112 may read the value of a sensor every n seconds, and may send the current sensor values to the applications when the sensors are read. In this example, the elapse of a period of n seconds, thereby causing a time to be read, is an example of an event. Any appropriate notion of an event may be used with the subject matter herein.

Regardless of what mechanism triggers an event (e.g., change in a sensor value, passage of time, etc.), when events are triggered sensor API 112 may communicate these sensor events 114 to a consumer of the events. Any type of program (e.g., application program, operating system component, device driver, etc.) may subscribe to, and consume, sensor events 114. However, one example of a component that may consume events is event generator 116. Event generator 116 generates higher-order events based on information that it receives from other sources. One such type of information is the low level sensor events 114 that sensor API 112 communicates from sensors. For example, sensor events 114 may indicates certain changes in acceleration and location, and event generator 116 may be a motion analyzer that determines, based on these sensor events 114, that a person is walking (or running, or driving, etc.). Thus, event generator 116 may generate events indicating that walking has started (or stopped, or paused, etc.) based on its analysis of the lower level sensor events 114. In determining what events have occurred, event generator 116 may use other data 118 in combination with sensor events 114. Other data 118 could be any type of data, such as a calendar, employee records, a name/address database, etc. Thus, if event generator 116 is a motion analyzer that discerns walking motion, event generator 116 could use information such as a person's calendar and the current date and time to determine that the person is walking to a meeting. If the calendar identifies whom the meeting is with, then event generator 116 could use a name/address database to determine the address to which the person is walking. Event generator 116 may draw conclusions from any type of event or non-event information. Regardless of what information event generator 116 uses to draw conclusions, event generator 116 may generate events (e.g., higher-order events 120) based on these conclusions.

The higher-order events 120 may be provided to an event consumer 122. For example, event consumer 122 may be a program (e.g., application, operating system component, device driver, etc.) that subscribes to event notifications. The subscription mechanism may be the same as, or similar to, the mechanism that a program would use to subscribe to sensor events 114. For example, sensor API 112 could be extended to allow programs to subscribe to higher-order events 120 as well as low-level sensor events 114. Or, a separate API could be created for higher-order events. Or, as a further example, a wrapper API could be created that provides a unified mechanism through which a program can subscribe to sensor events 114 through sensor API 112, and that also allows a program to subscribe to higher-order events 120.

Regardless of the mechanism that is used to subscribe to higher-order events 120, event consumer 122 may consume these events and may produce some kind of result based on the events. As a simple example, higher-order events 120 could include information about whether the owner of a particular device is walking, and where he or she is walking to. Event consumer 122 could be an application that a person installs on his or her handheld computing device to notify co-workers where he or she is at any given time. Thus, event consumer 122 could be an application that consumes higher-order events 120 in order to learn that the owner of the device is walking to a particular place. Event consumer 122 could then send notifications to his or her co-workers to inform those co-workers where the device owner is and where he or she is going.

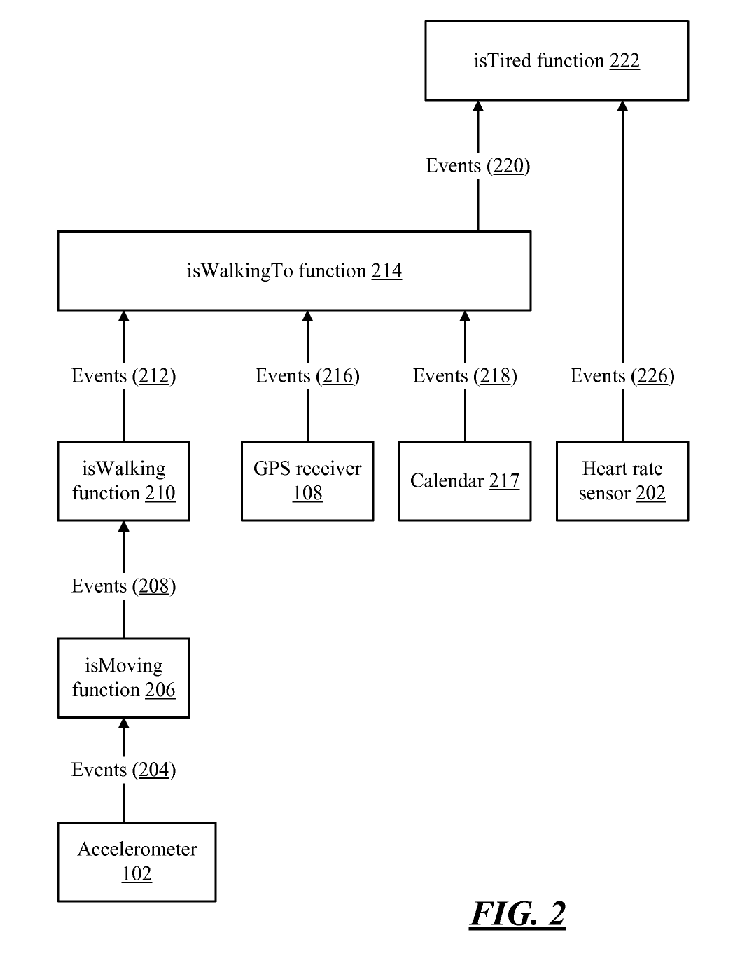

In the example of FIG. 1, only one level of higher-order events are produced. However, the event consumer—in addition to consuming the events—may generate its own events. Thus, higher-order events may build on each other to generate events at increasingly high levels of abstraction. Such events may be said to be “cascading,” in the sense that the existence of a first higher-order event depends on some low-level events, the existence of a second higher-order event depends on the first higher-order event, and so on. FIG. 2 shows an example of cascading higher-order events.

In FIG. 2, there are various sensors that provide the underlying low-level input. These sensors may include accelerometer 102, GPS receiver 108, and heart rate sensor 202. While each of these sensors generates low-level events, the events may be used as input to models at various levels of abstraction. Thus, in this example, accelerometer 102 generates events 204, which are used as input by “is Moving” function 206. For eample, the is Moving function may subscribe to accelerometer events using an event messaging service. The is Moving function 206 may determine, based on analysis of changes in the acceleration vector, whether the device to which accelerometer is attached is being carried by a person who is in motion. If the is Moving function 206 determines that such a person is moving, it may generate events 208. Events 208 may indicate changes in the motion status (e.g., motion has started, stopped, paused, etc.), and may also provide information about the nature of the motion. For example, events 208 may include certain data such as the apparent speed of the motion (as inferred from accelerometer readings). Another function, such as the “is Walking” function 210, may subscribe to events 208. The is Walking function may infer, based on an analysis of information contained in events 208 (e.g., speed of motion, frequency with which motion starts and stops, etc.), whether the type of motion in which the person is engaging is a walking motion. The is Walking function 210 may thus generate events relating to whether the motion in which the person is engaging is a walking motion (e.g., walking has started, walking has stopped, etc.).

It is noted at this point that the is Moving function 206 and the is Walking function 210 together show an example of cascading higher-order events. That is, the is Moving function 206 determines whether motion is occurring based on low-level accelerometer readings, and provides events that describe the existence of, and details of, that motion. These events are higher-order events, and the is Walking function 210 subscribes to these events. The is Walking function 210 then uses the information in these events to produce its own events 212. Events 212 depend on events 208, which depend on events 204, and in this sense the events may be said to have cascading dependencies that are used to build increasingly high-level abstractions about the motion. At the lowest level, a physical sensor (accelerometer 102) detects that acceleration is occurring. At the next level, this acceleration is interpreted as indicating that the device to which the accelerometer is attached is moving. At the next level, the motion is interpreted as being a walking motion.

In the cascading structure shown in FIG. 2, higher level abstractions can also be implemented. For example, the “is WalkingTo” function 214 attempts to determine where a person is walking based on other information. One example of such information is events 212 generated by the is Walking function 210. The is WalkingTo function 214 receives events 212 in order to determine whether a person is walking, and then uses other information to try to determine where the person is walking. Some of this other information may include events 216 from GPS receiver 108. The information may also include information from calendar 217, which may communicate with the is WalkingTo function 214 by sending events 218 to that function. For example, if a person is walking, and has a meeting on his calendar in the next half hour, and his latitude and longitude indicates he is in the vicinity of the scheduled location of the meeting, then it might be a reasonable inference that the person is walking to the meeting. The is WalkingTo function 214 may implement this type of high-level abstraction to infer that the person is walking to a particular meeting. Moreover, the is WalkingTo function 214 may generate its own set of events 220 based on this inference. For example events 220 may indicate whether a person has started walking to a meeting (or stopped, or paused, etc.), and may also indicate facts such as where the meeting is and whom it is with.

In the example of FIG. 2, cascading events may be used to implement further abstractions. For example, the is Tired function 222 attempts to infer whether a person is tired based on his heart rate and how far he is walking. Thus, the is Tired function 222 subscribes to events 220 in order to learn where the person is walking, and also subscribes to events 226 from heart rate sensor 202 in order to learn the person's heart rate. The is Tired function 222 may then use information about where the person is walking to infer how far that person has walked, and may then apply a model of human endurance to determine, based on distance walked and current heart rate, whether the person is tired. The is Tired function 222 may generate its own set of events, which can be consumed by further models, or by applications. For example, an application could consume the is Tired events, and could display an icon on a user's screen showing a level of fatigue (e.g., on some scale such as red-to-green, or 1-to-100), where the level of fatigue is calculated from the is Tired events.

As can be seen in FIG. 2, levels of abstraction may build on each other in a cascading structure. So, basic information such as the acceleration vector, the latitude and longitude, and a person's heart rate, can be used to be used to build increasingly abstract facts, such as tiredness. Once an event has been generated based on a high-level fact such as tiredness, a program can consume and use the high-level fact in much the same way that it could use a low-level fact from a sensor.

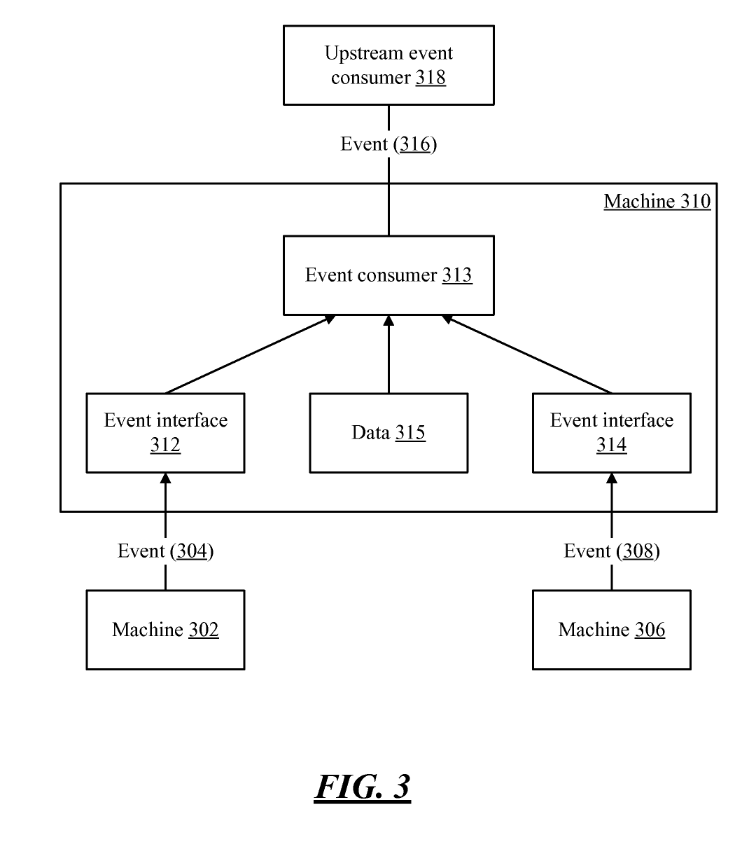

As noted above, the arrangement in which events are generated or consumed could be a single machine, or could comprise a plurality of machines (which may all be the same type of machine, or could be different types of machines). FIG. 3 shows an example scenario in which events are generated and consumed across a plurality of distinct machines in a distributed environment.

In the example of FIG. 3, machine 302 generates event 304, and machine 306 generates event 308. Machines 302 and 306 may include software that generates events based on sensor readings, or that generates events based on abstract reasoning about sensor readings and/or other data. For example, machine 302 may be a fixed machine that has a thermometer, and machine 306 may be a handheld computer that has an accelerometer and a GPS receiver. Event 304 may indicate the state of the thermometer reading, and event 308 may indicate a high-level inference about a person's motion based on accelerometer and GPS readings. Machines 302 and 306 may generate any type of events, based on any types of readings and/or reasoning.

The distributed environment in which machines 302 and 306 may exist allows processes on other machines to subscribe to events that are generated by machines 302 and 306. For example, machine 310 may comprise one or more event interfaces 312 and 314, through which software on machine 310 may subscribe to events on machines 302 and 306. For example, event interfaces 312 may provide a subscription mechanism through which processes on machine 310 may subscribe to events generated by machine 302. Similarly, event interface 314 may provide a subscription mechanism through which processes on machine 310 may subscribe to events generated by machine 302. While machine 310 is shown as using a separate event interface for the various different machines with which it communicates, machine 310 could provide a unified event interface through which processes could subscribe to events generated on any machine (including events generated by machines 302 and 306, and even events generated by machine 310).

One process on machine 310 that may subscribe to events is event consumer 313. Event consumer 313 consumes events that are generated elsewhere, and may also consume other data (e.g., data 315). Event consumer 313 may implement some type of model that uses events and other data to infer facts. Event consumer 313 may use the inferences that it draws to generate its own events, such as event 316. For example, event consumer might implement a model of a person's fatigue level, based on how much the person has traveled and the outdoor temperature. Event consumer 313 thus may receive the outdoor temperature (from machine 302's thermometer), and an indication of how far the person has walked (from a program on machine 306 that infers distance walked from GPS and accelerometer readings). The model might also take into account other factors such as the person's age. In such a case, data 315 might be database records that identify the owner of a particular device and the owner's age. Thus, data 315 might indicate that Joe is the owner of machine 306 (which, in this example, is a handheld computer), and might indicate that Joe is thirty years old. Based on this information, event consumer 313 may determine whether Joe is fatigued, and may generate events, such as event 316, to indicate when Joe has become fatigued and/or when Joe has recovered from fatigue.

Event 316 may then be consumed by an upstream event consumer 318, which might be on a different machine. Upstream event consumer 318 may make use of event 316 to produce a result or to provide information. For example, Joe might be an employee of a company, and the medical department of that company may want to be able to tell Joe to rest when he has become fatigued. Thus, upstream event consumer 318 might be an application on the medical department's computer, which displays an alert to an operator when a model indicates that an employee has become fatigued, so that the operator can take appropriate action (such as calling the employee and requesting that he take a rest).

Thus, the foregoing scenario of FIG. 3 shows an example in which events are generated and consumed across machines in a distributed environment.

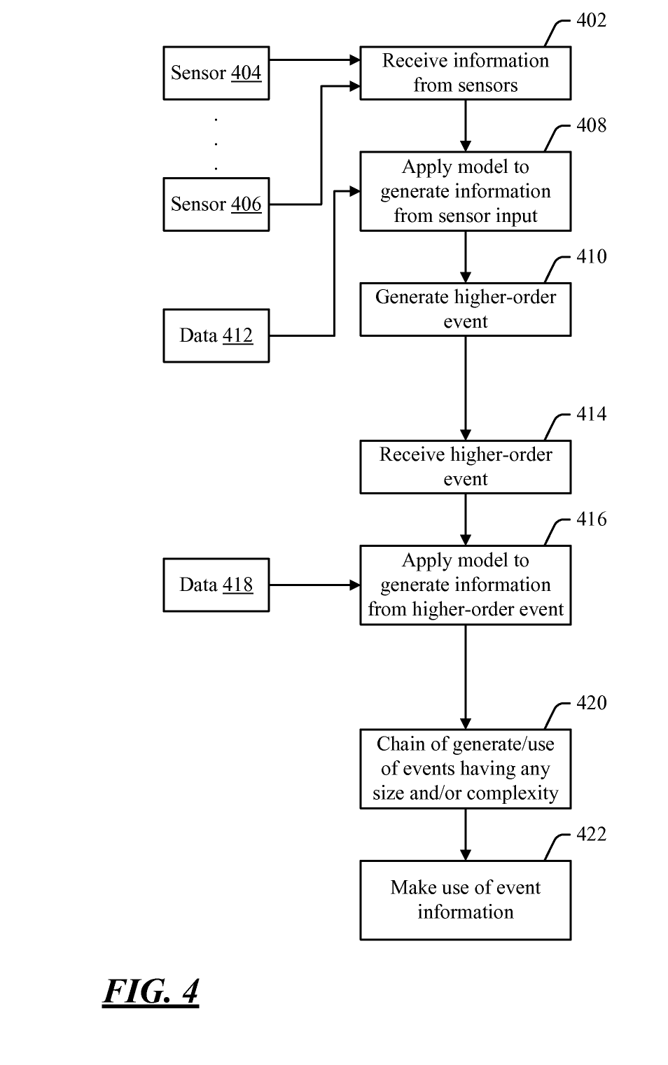

FIG. 4 shows, in the form of a flow chart, an example process in which events may be generated and/or consumed. Before turning to a description of FIG. 4, it is noted that the flow diagram contained in FIG. 4 is described, by way of example, with reference to components shown in FIGS. 1-3, although this process may be carried out in any system and is not limited to the scenarios shown in FIGS. 1-3. Additionally, the flow diagram in FIG. 4 shows an example in which stages of a process are carried out in a particular order, as indicated by the lines connecting the blocks, but the various stages shown in this diagram may be performed in any order, or in any combination or sub-combination.

At 402, information may be received from one or more sensors. Sensors may be the sensors described above (e.g., accelerometer, thermometer, light sensor, GPS receiver, etc.), or could be any type of sensor. Moreover, there may be any number of sensors. FIG. 4, by way of example, shows two sensors 404 and 406, although there could be any number of sensors (as indicated by the ellipsis between sensors 404 and 406). The information from sensors could be received in the form of events, but could also be received in any appropriate form. For example, there may be a message service that allows a program to subscribe to sensor events, or there could be a set of functions that a program could call to read a sensor on demand.

At 408, a model may be applied to the received sensor input in order to generate information. Model may also receive some other data 412, and the model may use both the sensor input and data 412 as a basis to infer a fact. (In one of the examples above, a model uses information about a person's age from a database; this age information is an example of data 412.) As described above, models could be used to infer facts such as motion, walking, fatigue, or any other type of fact.

At 410, a higher-order event may be generated. A higher-order event is an event that is based on some form of reasoning, rather than simply a report of raw, low-level data. The higher-order event may be based on information generated by the model that was applied at 408.

At 414, the higher-order event is received by an event consumer. The higher-order even may be received by a consumer on the same machine on which the event was generated, or may be received by an event consumer on a different machine.

The higher-order event that is received at 414 may be used by an application, or the event may be used as input to a further event generator in order to generate further events. Thus, at 416 a model may be applied to the higher-order event (and, possibly, to some other data 418) in order to generate an additional higher-order event. At 420, events may be generated and/or consumed in a chain that has arbitrary size and complexity. For example, as discussed above FIG. 2 shows a scenario in which events are used in succession to build increasingly abstract models. Thus, events may be used as input to other models; those models may generate new events; and so on.

At some point, an event is generated that is consumed by an application or other program that makes use of the event (at 422). An application may create data, or may take some tangible action, based on an event. To use one example described above, an event might indicate that an employee has become tired, which may cause an application to display an alert, which may cause the employee to rest in order to regain strength.

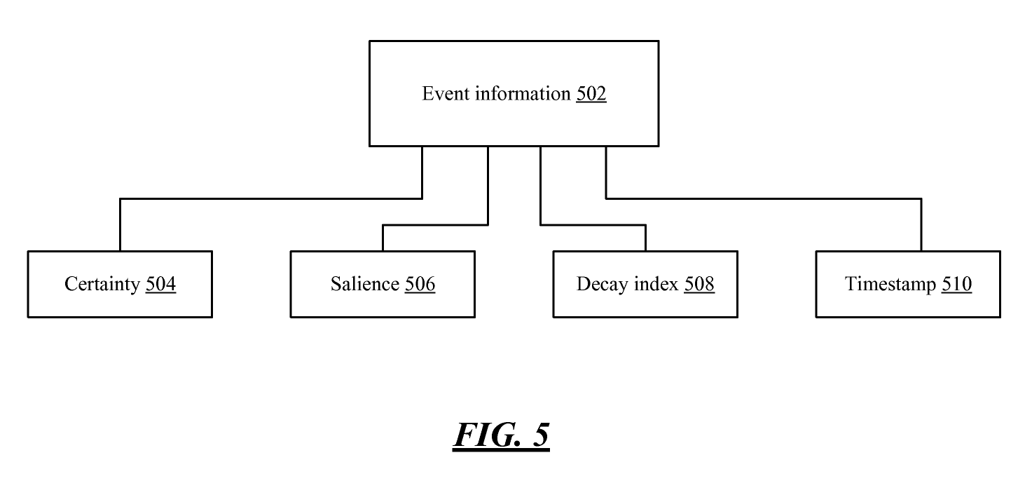

In the examples above, the information that is communicated as part of an event is typically the change in status of some fact (e.g., a change in temperature, a change in whether a person is walking, etc.). However, the information included with any event may include other types of information. FIG. 5 shows some example kinds of information that may be communicated with an event.

Event information 502 may include information such as certainty 504, salience 506, decay index 508, and timestamp 510. This information may support certain ways of using the information contained in events.

Certainty 504 refers to the level of confidence that a particular event that has been generated accurately describes the fact that it is intended to describe. For example, the component that generates such an event might provide an assessment of that component's certainty that the event correctly describes the relevant facts. Thus, in the examples above, an event might indicate that a person has started walking or has stopped walking. Determining whether a person is walking, however, may depend on a model that infers the fact that a person is walking from other facts, such as changes in an acceleration vector or changes in location. There may be some ambiguity in the interpretation of such facts. Thus, a model may conclude that a person is walking, but that same model may also find that there is less than a perfect correlation between the observed physical sensor readings and the archetypal sensor readings that are characteristic of the walking motion. Thus, the model might conclude that it is 70% certain that the person is walking. In such a case, the model might generate an event indicating that a person has commenced walking, and also provide a certainty level of 70% with that event. Thus, models that rely on whether someone is walking can take that level of certainty into account.

Salience 506 refers to the relevance that a particular event has to its consumer. In some cases, programs that generate events are intended to be used by specific programs—e.g., the manufacturer of a mail client might produce a separate event generator to indicate when mail has arrived, so that the mail client can subscribe to “mail arrived” events through an existing event mechanism. Thus, the event generator might have some algorithm to assess which mail would be interesting to a user and which mail is not. Thus, whenever mail arrives a “mail arrived” event could be generated, but that event might come with an indication of the salience that the event generator, or the presumed consumer of the event, would ascribe to the event (e.g., based on some determination of how significant the event generator believes the mail client would find a given piece of mail). Such an event generator may be in a position to judge the salience that the consumer will ascribe to an event if the event generator has been designed with a particular event consumer in mind (as in the example where an event generator is designed for a specific mail client).

Decay index 508 refers to the fact that information communicated by events may become less reliable as time passes. For example, a model may be able to determine with a high level of accuracy that a person is walking. But people start and stop walking rather frequently, so an event indicating that a person has started walking may be very reliable one second after the event has been generated, but may be considerably less reliable five minutes later. Decay index 508 may indicate how the reliability of information changes with the passage of time. For example, decay index 508 might indicate the half-life of the information, or might indicate an absolute time limit on the value of the information. Inasmuch as the reliability of information decays over time, timestamp 510 may be provided with an event so that the reliability of information can be determined using the timestamp 510 and the decay index 508. For example, if decay index 508 indicates that an event has a half-life of 5 minutes and timestamp 510 indicates that the event was issued ten minutes ago, then it can be determined that the reliability of the information is one-quarter what it was when the event was first issued.

In general, certainty 504, salience 506, decay index 508, and timestamp 510 are examples of information that characterizes the meaning or significance of a particular fact.

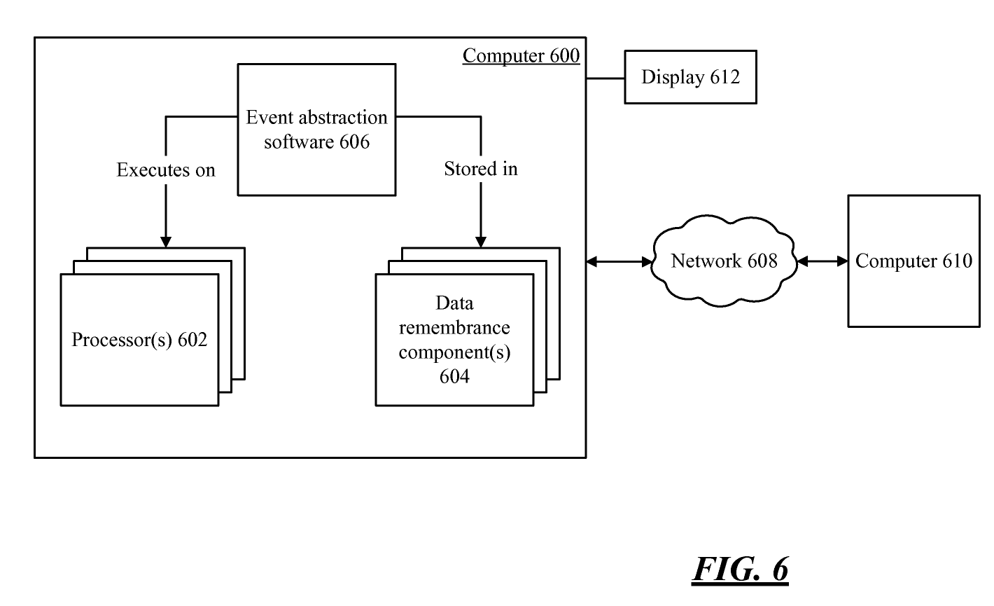

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is event abstraction software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable storage media. (A tangible medium, such as an optical disk or magnetic disk, is an example of a storage medium.) Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through network 608. Computer 610, which may be similar in structure to computer 600, is an example of a device that can be connected to computer 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to use events, wherein the executable instructions, when executed by a computer, cause the computer to perform acts comprising:
receiving a first event at a first component;
applying a model to said first event to generate a second event, said second event comprising notification of a fact that said model infers from first information that comprises said first event, said second event further comprising data that characterizes the meaning or significance of said second event;
receiving, at a second component, said second event; and
making use of said second event to perform an action.

2. The one or more computer-readable storage media of claim 1, wherein said data that characterizes the meaning or significance of said second event comprises an indication of said first component's assessment of a level of certainty with which said second event characterizes said fact.

3. The one or more computer-readable storage media of claim 1, wherein said first component generates said second event for consumption by said second component, and wherein said data that characterizes the meaning or significance of said second event comprises an indication said of said first component's assessment of the salience that said second component ascribes to said second event.

4. The one or more computer-readable storage media of claim 1, wherein said data that characterizes the meaning or significance of said second event comprises an indication of the rate at which accuracy of said second event decays.

5. The one or more computer-readable storage media of claim 1, wherein said first event comprises an indication of a reading taken by a sensor that detects a physical aspect of an environment surrounding a machine to which said sensor is attached.

6. The one or more computer-readable storage media of claim 1, wherein said applying of said model comprises:
receiving second information from a database, and using said second information to generate said second event.

7. The one or more computer-readable storage media of claim 1, wherein said first event is generated at a first machine, and wherein said second event is generated at a second machine that is distinct from said first machine.

8. A method of using events, the method comprising:
using a processor to perform acts comprising:
receiving a first event;
applying a first model to first information that comprises said first event to generate a second event, said second event comprising notification of a fact that said first model infers from said first information, said second event further comprising an indication of said first model's assessment of a level of certainty that said second event describes said fact; and
sending said second event to a component that implements a second model that is distinct from said first model, wherein said second model takes an action based on said second event.

9. The method of claim 8, wherein said second event further comprises an indication of said second model's assessment of the rate at which accuracy of said second event decays.

10. The method of claim 8, further comprising:
including, in said first event, an assessment of the salience that said component will ascribe to said second event.

11. The method of claim 8, wherein said first event comprises data read from a physical sensor that is attached to a machine at which said first event is generated.

12. The method of claim 8, wherein said first information further comprises data read from a database, and wherein said first model generates said second event based on said first event and on said data.

13. The method of claim 8, further comprising:
using said second model to perform a tangible action that is based on said second event.

14. The method of claim 8, wherein said first event is generated on a first machine, and wherein said first model is applied to said first event on a second machine that is distinct from said first machine.

15. A system for using events, the system comprising:
a first machine that comprises a sensor that detects a physical condition present at said first machine, said first machine comprising software that generates a first event that comprises an indication of a value of said sensor, said first machine comprising a mechanism that allows components to subscribe to events relating to said sensor; and
a second machine that is distinct from said first machine, said second machine comprising a first program that subscribes to said first event, said first program implementing a first model that derives a first fact from information that comprises said first event, said first program generating a second event that comprises an indication of said first fact and an indication of a level of certainty that said second event accurately describes said first fact.

16. The system of claim 15, wherein said second event further comprises:
an assessment, by said first program, of a rate at which accuracy of said second event decays.

17. The system of claim 15, further comprising:
a third machine that is distinct from said first machine and from said second machine, said third machine comprising a second program that subscribes to said second event, said second program implementing a second model, said second model using said second event and said level of certainty to derive a second fact that is based on said second event and that is further based on said level of certainty.

18. The system of claim 15, wherein first program generates said second event for a second program, and wherein said second event comprises an assessment, by said first program, of the salience that said second program will ascribe to said first program.

19. The system of claim 15, wherein said first program retrieves data from a database, and wherein said information further comprises said data.

20. The system of claim 15, further comprising:
a third program that consumes said second event and that produces a tangible result based on said second event.
